(19) United States
(12) Patent Application Publication
(10) Pub. No.: US 2006/0036024 A1
(43) Pub. Date: Feb. 16, 2006

(54) RELEASE COATING COMPOSITION FOR TAPE

(76) Inventors: Bin-Yen Yang, Taipei City (TW); Wataru Shimokawa, Tokyo (JP); Chi-Lin Kao, Taipei City (TW); Chao-Yo Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,740

(22) Filed: Apr. 14, 2005

(30) Foreign Application Priority Data
Aug. 12, 2004 (TW) 93124166

(51) Int. Cl. C08L 31/00

(52) U.S. Cl. 524/556; 524/366

(57) ABSTRACT

A release coating composition for tapes is provided. The release coating composition includes: (a) 75-95 part per hundred (phr) alkyl (meth)acrylate type monomer; (b) 5-15 phr hydroxy alkyl (meth)acrylate type monomer; (c) 1-5 phr unsaturated carboxylic acid type monomer; (d) 0.1-5.0 phrunsaturated crosslinkng type monomer, and (e) 5-20 phr protective colloid. The sum of the alkyl acrylate type monomer (a), the hydroxy alkyl (meth) acrylate type monomer (b), the unsaturated carboxylic acid type monomer (c), and the unsaturated crosslinkng type monomer (d) amounts to 100 phr. The phrs of the protective colloid (e) are computed based on the sum of the alkyl (meth)acrylate monomer, the hydroxy alkyl acrylate type monomer, the unsaturated carboxylic acid type monomer, and the unsaturated crosslinking type monomer.

### CROSS-REFERENCE TO RELATED APPLICATION

This application claims the priority benefit of Taiwan application serial no. 93124166, filed on Aug. 12, 2004. All disclosure of the Taiwan application is incorporated herein by reference.

### BACKGROUND OF THE INVENTION

1. Field of the Invention

The present invention relates to a release coating composition for tape, and more particularly to a release coating composition for tape that is environmental-friendly.

2. Description of the Related Art

Tapes are used to attach or fix objects. Masking tapes, also known as crepe paper tapes, have been widely used by the industry. For example, crepe paper tapes are used in car painting to cover the parts of the cars that do not require painting. In the electronic industry, crepe paper tapes are used to attach pins of electronic devices, such as resistors or capacitors, for signal transmission.

In addition to an adhesive layer coated on the bottom surface of the tape substrate, a release coating layer is coated on the top surface of the tape substrate to provide a desired releasing force. In these applications, crepe paper tapes are exposed to volatile solvents. Accordingly, the release coating layer should comprise features such as desired solvent resistance, high-temperature resistance and aging resistance, especially the aging resistance. In addition, if the composition of the release coating layer migrates to the adhesive layer on the bottom surface of the tape substrate, the peeling-off force of the tape is increased and the adhesion of the tape decays. These changes affect the quality and life span of the tape. Under high temperature and high humidity, it is required that the composition of the release coating layer on the top surface of the tape substrate not migrate to the adhesive layer on the bottom surface of the tape substrate.

The prior art release coating layer of the crepe paper tape uses compositions which are polymerized with acrylic monomers such as acrylate resin. Acrylonitrile monomer is usually added to enhance the solvent resistance and to provide a desired release force of the composition. However, acrylonitrile monomer is toxic and harmful to human beings and the environment in the production and on the application.

### SUMMARY OF THE INVENTION

Accordingly, the present invention is directed to a release coating composition for tape that avoids the use of toxic chemicals as described in the prior art release coating composition. In addition, the release coating composition according to the present invention has the desired release force, the features of solvent resistance, high-temperature resistance and aging resistance.

The present invention discloses a release coating composition for tape. The release coating composition comprises: (a) 75-95 part per hundred (phr) alkyl (meth)acrylate type monomer; (b) 5-15 phr hydroxy alkyl (meth)acrylate type monomer; (c) 1-5 phr unsaturated carboxylic acid type monomer; (d) 0.1-5.0 phr unsaturated crosslinking type monomer, and (e) 5-20 phr protective colloid. The sum of the alkyl (meth) acrylate type monomer (a), the hydroxy alkyl (meth) acrylate type monomer (b), the unsaturated carboxylic acid type monomer (c), and the unsaturated crosslinking type monomer (d) amounts to 1 00 phr. The phrs of the protective colloid (e) are computed based on the sum of the alkyl (meth)acrylate monomer (a), the hydroxy alkyl (meth)acrylate type monomer (b), the unsaturated carboxylic acid type monomer (c), and the unsaturated crosslinking type monomer (d).

The present inveniton replaces toxic acrylonitrile with non-toxic chemicals in the release coating composition. Therefore, the use of the release coating composition of the present invention will not affect human beings and the environment in the production and on the application. The release coating composition according to the present invention has the desired release force and the features of solvent resistance, high-temperature resistance and aging resistance.

The above and other features of the present invention will be better understood from the following detailed description of the preferred embodiments of the invention.

### DESCRIPTION OF SOME EMBODIMENTS

The present invention provides a release coating composition for tape, which is not harmful to human beings and the environment and has the features of solvent resistance, high-temperature resistance and aging resistance. By emulsion polymerization, the release coating composition comprises: (a) 75-95 part per hundred (phr) alkyl (meth)acrylate type monomer; (b) 5-15 phr hydroxy alkyl (meth)acrylate type monomer; (c) 1-5 phr unsaturated carboxylic acid type monomer; (d) 0.1-5.0 phr unsaturated crosslinking type monomer, and (e) 5-20 phr protective colloid. The sum of the alkyl (meth) acrylate type monomer (a), the hydroxy alkyl (meth) acrylate type monomer (b), the unsaturated carboxylic acid type monomer (c), and the unsaturated crosslinking type monomer (d) amounts to 100 phr. The phrs of the protective colloid (e) are computed based on the sum of the alkyl (meth) acrylate monomer (a), the hydroxy alkyl (meth) acrylate type monomer (b), the unsaturated carboxylic acid type monomer (c), and the unsaturated crosslinking type monomer (d).

In this embodiment, the alkyl group of the alkyl (meth) acryl ate monomer (a) comprises 1 to 20 carbon atoms. It is more preferred that the alkyl group of the alkyl (meth)acrylate monomer comprises 1 to 1 0 carbon atoms. In some embodiments, the alkyl (meth)acrylate type monomer comprises, for example, alkyl acrylate mononer or alkyl methacrylate mononer. The alkyl acrylate monomer comprises, for example, ethyl acrylate, n-butyl acrylate, 2-ethylhexyl acrylate or decyl acrylate. The alkyl methacrylate mononer comprises, for example, methyl methacrylate (MMA) or butyl methacrylate.

In addition, the alkyl group of the hydroxy alkyl (meth)acrylate type monomer (b) comprises 1 to 1 0 carbon atoms. It is preferred that the alkyl group of the hydroxy alkyl (meth)acrylate type monomer comprises 1 to 5 carbon atoms. In some embodiments, the hydroxy alkyl (meth)acrylate type monomer comprises, for example, hydroxy alkyl acrylate mononer or hydroxy alkyl methacrylate mononer. The hydroxy alkyl acrylate mononer comprises, for example, hydroxy ethyl acrylate or hydroxy propyl acrylate. The hydroxy alkyl methacrylate mononer comprises, for example, hydroxy ethyl methacrylate or hydroxy propyl methacrylate.

The unsaturated carboxylic acid type monomer (c) comprises, for example, methacrylic acid (MAA), acrylic acid, itaconic acid, maleic acid or fumaric acid.

The unsaturated corsslinking type monomer (d) comprises, for example, metal chelating agent, glycidyl acrylate, allyl glycidyl ether, glycidyl methacrylate, acrylamide, methylol acrylamide, N-metylol acrylamide or silane.

In addition, the amount of the protective colloid (e) is computed based on the 100 phr of the alkyl acrylate type monomer (a), the hydroxy alkyl acrylate type monomer (b), the unsaturated carboxylic acid type monomer (c) and the unsaturated crosslinking type monomer (d). The protective colloid (e) comprises polyvinyl alcohol (PVA) or lecithin.

In addition, the release coating composition may further comprise at least one of surfactant, initiator, buffer and de-ionized (DI) water. In some embodiments, when the sum of the alkyl acrylate type monomer (a), the hydroxy alkyl acrylate type monomer (b), the unsaturated carboxylic acid type monomer (c), and the unsaturated crosslinking type monomer (d) amounts to 100 phr, the surfactant can range from 0.1 to 3.0 phr. Further, the initiator can range from 0.1 to 2.0 phr, and the buffer can range from 0.1 to 0.5 phr.

In some embodiments, the surfactant is additionally included and is selected from a group consisting of a nonionic surfactant and an anionic surfactant. The surfactant stabilizes the emulsion polymerization in order to generate the features of solvent resistance and aging resistance.

In some embodiments, when the sum of the alkyl acrylate type monomer, the hydroxy alkyl acrylate type monomer, the unsaturated carboxylic acid type monomer, and the unsaturated crosslinking type monomer amounts to 1 00 phr, the nonionic surfactant ranges from 0.1 to 1.0 phr. The nonionic surfactant comprises polyoxethyene nonyl phenyl ether, polyoxethyene octyl phenyl ether, polyethylene gylcol alkyl phenol ether, isosorbide fatty acid or polyethylene gylcol isosorbide fatty acid.

In some embodiments, when the sum of the alkyl acrylate type monomer, the hydroxy alkyl acrylate type monomer, the unsaturated carboxylic acid type monomer, and the unsaturated crosslinking type monomer amounts to 100 phr, the anionic surfactant ranges from 0.4 to 3.0 phr. The anionic surfactant comprises sodium dodecyl benzene sulphonate, sodium dodecylsulfonate, sulfonic acid group, dodecyl phenyl ether disodium sulfonate, disodium n-octodecyl sulfonate succinate or ammonium polyoxethyene nonyl phenyl ether sulfate.

The initiator above comprises, for example, sodium persulfate, ammonium persulphate or potassium persulfate. The buffer above comprises, for exmaple, sodium bicarbonate or sodium acetate.

The emulsion polymization is performed in a reaction tank in which the alkyl acrylate type monomer (a), the hydroxy alkyl acrylate type monomer (b), the unsaturated carboxylic acid type monomer (c), the unsaturated crossling type monomer (d), the protective colloid (e), and the surfactant are mixed. The initator, the buffer and the DI water are added to the reaction tank. The reaction tank is then heated, wherein the temperature of the reaction tank is between 50° C. to 90° C. for 5 to 10 hours. After the reaction, the emulsion of the release coating composition is obtained.

The average particle size in the emulsion of the release coating composition according to the present invention ranges from 0.1 μm to 0.5 μm. The glass-transition temperature, Tg, of the release coating composition ranges between 0° C. and 70° C. The solid content of the release coating composition is 20% to 60% of the total weight.

Following are the descriptions of experiments and embodiments of the present invention. The present invention, however, is not limited thereto.

Following are the descriptions of the first experimental embodiment. First, 80 g DI water, 3.0 g polyoxethyene nonyl phenyl ether and 3.0 g ammonium polyoxethyene nonyl phenyl ether sulfate are mixed to form Solution A.

67.5 g n-butyl acrylate monomer, 60.0 g methyl methacrylate (MMA), 15.0 g hydroxy ethyl methacrylate (HEMA) and 4.5 g methacrylic acid monomer are mixed to form Solution B.

300 g DI water and 22.5 g lecithin are mixed to form Solution C.

37.4 g DI water and 1.5 g potassium persulfate and 0.8 g sodium bicarbonate are mixed to form Solution D.

Solutions A and B are poured into the pre-emulsion tank and mixed quickly to form pre-emulsion.

Solutions C and D are then poured into the reaction tank. The reaction tank comprises a mixer, a thermometer, a heater, a reflow condenser, a five-neck and a 1-liter vessel with a round bottom.

The heater heats the reaction tank. When the temperature of the reaction tank reaches 70° C. to 75° C., 1 0% of the pre-emulsion is dropped into the reaction tank. The time for dropping the 10% of the pre-emulsion into the reaction tank is 20 to 30 minutes and the temperature of the reaction tank is maintained at 70° C. to 75° C.

The temperature of the reaction tank is then raised to 80° C. to 85° C. At the raised temperature, the remaining 90% of the pre-emulsion is poured into the reaction tank in 240 minutes. The reaction condition is maintained for 90 minutes. Then the reaction tank is cooled down to the room temperature. Accordingly, the emulsion of the release coating composition of the present invention is generated.

Following are the descriptions of the second experimental embodiment. The second experimental embodiment comprises steps similar to those of the first experimental embodiment. The only difference between the first and the second experimental embodiments is that methylol acrylamide is added into Solution B in the second experimental embodiment. It means that Solution B of the second experimental embodiment comprises 67.5 g n-butyl acrylate monomer, 60.0 g methyl methacrylate (MMA), 15.0 g hydroxy ethyl methacrylate (HEMA), 4.5 g methacrylic acid monomer and 3.0 g methylol acrylamide.

Following is the description for preparing a comparison sample. The comparison sample does not comprise lecithin, i.e. the protective colloid, in Solution C.

The emulsions of the first experimental embodiment, the second experimental embodiment and the comparison sample have different properties due to the use of different chemicals or processes. Following are the descriptions of different testing methods to test the properties of the emulsions. The testing methods comprise solid content test, viscosity test, T-peeling test, steel-plate adhesion test, solvent resistance test and high-temperature resistance test. In the solid content test, a pan is weighted to obtain the weight of the pan, “a”. The emulsions of these embodiments are weighted in the pan to obtain the weight, “b”. The pan is then placed in an oven with a temperature of 150° C. for 1 hour. After baking, the weight of the pan,“c”, is recoded. The following formula is then used to compute the solid content of the release coating composition: (%)={(c−a)/b}×100.

The viscosity test is performed by using a Brook field viscometer. The testing conditions include using a No. 4 spindle with a rotational speed of 30 rpm and performing the test at a temperature of 25° C. The unit of the viscosity of the emulsions is centi poise (cps).

In addition, the T-peeling test uses CM35 crepe paper tape provided by Four Pillars Enterprise Co. Ltd. for attaching the release coating test samples. A 2-kgw roller then rolls the test samples back and forth for once. The test samples are then placed in an environment with a temperature of 23° C. and 50% humidity for three days. 25 mm-by-150 mm samples are then cut out from the test samples. A 50-mm release coating is then peeled off form the CM35 crepe paper tape and is clipped by a lower clip. The CM35 crepe paper tape is clipped by an upper clip. The CM35 crepe paper tape and the release coating sample are peeled off from each other at a speed of 300 mm/min. During the peeling-off, the release coating sample and the CM35 crepe paper tape form a T-shape. The unit for measuring the weight of the peeling-off force is g/25 mm.

The steel-plate adhesion test is based on ASTM D-1000, which is a testing method of pressure-sensitive adhesion coating tape for electrical and electronic equipment published by American Society for Testing and Materials in 1999.

The solvent resistance test is performed by obtaining a 25 mm-by-100 mm sample and immersing the sample in toluene for 30 minutes. This sample is then placed in an environment with a temperature of 100° C. for 10 minutes. Afterwards, the sample is then cooled to the room temperature to observe whether the release coating has dissolved.

The high-temperature resistance test is performed by cutting out a 25 mm-by-100 mm sample and placing the sample in an oven with a temperature of 150° C. for 1 hour. Then the sample is ground with the release coating layer for six times to observe whether peeling-off or fragility occurs.

The testing results of the release coating compositions of the first experimental embodiment, the second experimental embodiment and the comparison sample are shown in Table 1 below. The method for preparing the samples described above uses 64 grams per square meter crepe paper as a substrate. The substrate is then coated with the release coating composition. After the coating, the samples are placed in an oven with a temperature of 135° C. for 5 minutes. The weight of the samples is 10±2 g/m².

TABLE 1

| | | | Comparison |
|---|---|---|---|
| | Experiment 1 | Experiment 2 | sample |
| Solid content(%) | 30 | 30 | 27 |
| Viscosity (cps) | 12 | 25 | 10 |
| T peeling-off force (g/in) | 280 | 260 | 750 |
| Steel-plate adhesive force | 1020 | 1045 | 1025 |
| (g/in) | | | |
| Solvent resistance | ∘ | ∘ | ∘ |
| Heat resistance | ∘ | ∘ | ∘ |

∘: Pass the standard

From Table 1, the solid content of the first experimental embodiment and the second experimental embodiment are 30%. The viscosities of the first and the second experimental embodiments are 12 cps and 25 cps, respectively. The cross-linker added in the second experimental embodiment may change the viscosity of the release coating composition. Accordingly, the viscosity of the second experimental embodiment is higher than that of the first experimental embodiment.

After the aging treatments for the release coating compositions of the first experimental embodiment, the second experimental embodiment and the comparison sample, the testing results are shown in Table 2. During the aging treatments, the release coating compositions are placed in the oven for three days, wherein the temperature of the oven is 65° C. and the humidity is 80%. The samples are then placed in the oven with a temperature of 23° C. and 50% humidity for an hour.

TABLE 2

| | | | Comparison |
|---|---|---|---|
| | Experiment 1 | Experiment 2 | sampel |
| T peeling-off force (g/in) | 282 | 264 | 850 |
| Steel-plate adhesive force | 1015 | 1040 | 1043 |
| (g/in) | | | |
| Solvent resistance | ∘ | ∘ | ∘ |
| Heat resistance | ∘ | ∘ | ∘ |

∘: Pass the standard

From the testing at the room temperature for the release coating compositions of the first experimental embodiment, the second experimental embodiment and the comparison sample, the testing results of T peeling-off force and the steel-plate adhesive force are consistent. Comparing the testing results of the release coating compositions after the aging treatment, the testing results of the release coating compositions without the aging treatment do not change substantially. Accordingly, the release coating compositions of the first experimental embodiment and the second experimental embodiment have desired aging resistance. Moreover, the first experimental embodiment and the second experimental embodiment have desired solvent resistance and heat resistance.

Accordingly, adhesive is coated on one side of the tape, and the release coating composition of the present invention is coated on the other side of the tape. In addition to being environmental-friendly, the tape generated thereby has desired solvent resistance, high-temperature resistance and aging resistance. The release coating composition can be used in various kinds of tapes, such as crepe paper tapes, polypropylene tapes, polyester tapes, protective tapes or double-coated tapes.

Following are the descriptions of comparison of practical application of the release coating compositions of the first experimental embodiment, the second experimental embodiment and the comparison sample. The comparison test comprises an experimental group and a comparison group. The experimental group is a crepe paper tape, wherein an adhesive is coated on one side of the tape, and one of the releasing compositions of the first experimental embodiment, the second experimental embodiment and the comparison sample is coated on the other side of the tape. The comparison group is a crepe paper tape, wherein adhesive is coated on one side of the tape, and the other side of the tape is not coated with the release coating composition. The release coating composition of the comparison sample of the experimental group has large T peeling-off force. Further, after the aging treatment, the T peeling-off force of the release coating composition becomes so great that the releasing composition does not pass the standard. Comparing the testing results obtained from the test at the room temperature and the aging treatment for the comparison group, the T peeling-off forces of the release coating composition in both tests are so large that the release coating compositions cannot be peeled. Therefore, the release coating compositions of the first and second experimental embodiments pass the standard.

Accordingly, the present invention has following features.

1. The present inveniton replaces acrylonitrile monomer with the non-toxic chemicals in the release coating composition. Further, the use of the release coating composition of the present invention does not affect human beings and the environment.

2. According to the experimental and the comparison embodiments, the release coating composition of the present invention has the features of solvent resistance, high-temperature resistance and aging resistance.

3. The release coating composition can be used in various kinds of tapes, such as crepe paper tapes, polypropylene tapes, polyester tapes, protective tapes or double-sided tapes. The release coating composition of the present invention can be used on other objects, and not limited to just tapes.

Although the present invention has been described in terms of exemplary embodiments, it is not limited thereto. Rather, the appended claims should be constructed broadly to include other variants and embodiments of the invention, which may be made by those skilled in the field of this art without departing from the scope and range of equivalents of the invention.

What is claimed is:

1. A release coating composition for tape, comprising:
(a) 75-95 part per hundred (phr) alkyl (meth)acrylate type monomer;
(b) 5-15 phr hydroxy alkyl (meth)acrylate type monomer;
(c) 1-5 phr unsaturated carboxylic acid type monomer;
(d) 0.1-5.0 unsaturated crosslinkng type monomer, and
(e) 5-20 phr protective colloid, wherein a sum of the alkyl (meth)acrylate type monomer (a), the hydroxy alkyl acrylate type monomer (b), the unsaturated carboxylic acid type monomer (c) and the unsaturated crosslinkng type monomer (d) amounts to 100 phr, and the phrs of the protective colloid (e) are computed based on the sum of the alkyl acrylate monomer (a), the hydroxy alkyl acrylate type monomer (b), the unsaturated carboxylic acid type monomer (c) and the unsaturated crosslinkng type monomer (d).

2. The release coating composition for tape of claim 1, wherein an alkyl group of the alkyl (meth)acrylate monomer comprises 1 to 20 carbon atoms.

3. The release coating composition for tape of claim 1, wherein an alkyl group of the alkyl (meth)acrylate monomer comprises 1 to 10 carbon atoms.

4. The release coating composition for tape of claim 3, wherein the alkyl (meth)acrylate monomer comprises ethyl acrylate, n-butyl acrylate, 2-ethylhexyl acrylate or decyl acrylate, ormethyl methacrylate (MMA) or butyl methacrylate.

5. The release coating composition for tape of claim 1, wherein an alkyl group of the hydroxy alkyl (meth)acrylate type monomer comprises 1 to 10 carbon atoms.

6. The release coating composition for tape of claim 1, wherein an alkyl group of the hydroxy alkyl (meth)acrylate type monomer comprises 1 to 5 carbon atoms.

7. The release coating composition for tape of claim 1, wherein the hydroxy alkyl (meth)acrylate mononer comprises hydroxy ethyl acrylate, hydroxy propyl acrylate, hydroxy ethyl methacrylate or hydroxy propyl methacrylate.

8. The release coating composition for tape of claim 1, wherein the unsaturated carboxylic acid type monomer comprises methacrylic acid (MAA), acrylic acid, itaconic acid, maleic acid or fumaric acid.

9. The release coating composition for tape of claim 1, wherein the unsaturated crosslinking type monomer comprises metal chelating agent, glycidyl acrylate, allyl glycidyl ether, glycidyl methacrylate, acrylamide, methylol acrylamide, N-metylol acrylamide or silane.

10. The release coating composition for tape of claim 1, wherein the protective colloid comprises polyvinyl alcohol (PVA) or lecithin.

11. The release coating composition for tape of claim 1, further comprising a surfactant, wherein the surfactant is one selected from the group consisting of a nonionic surfactant and an anionic surfactant.

12. The release coating composition for tape of claim 11, wherein when the sum of the alkyl acrylate type monomer, the hydroxy alkyl acrylate type monomer, the unsaturated carboxylic acid type monomer, and the unstaturated crosslinking type monomer amounts to 100 phr, the nonionic surfactant ranges from 0.1 to 1.0 phr.

13. The release coating composition for tape of claim 11, wherein the nonionic surfactant comprises polyoxethyene nonyl phenyl ether, polyoxethyene octyl phenyl ether, polyethylene glycol alkyl phenol ether, isosorbide fatty acid or polyethylene glycol isosorbide fatty acid.

14. The release coating composition for tape of claim 11, wherein when the sum of the alkyl acrylate type monomer, the hydroxy alkyl acrylate type monomer, the unsaturated carboxylic acid type monomer, and the unstaturated crosslinking type monomer amounts to 100 phr, the anionic surfactant ranges from 0.4 to 3.0 phr.

15. The release coating composition for tape of claim 11, wherein the anionic surfactant comprises sodium dodecyl benzene sulphonate, sodium dodecylsulfonate, sulfonic acid group, dodecyl phenyl ether disodium sulfonate, disodium n-octodecyl sulfonate succinate or ammonium polyoxethyene nonyl phenyl ether sulfate.

16. The release coating composition for tape of claim 1, further comprising an initiator, a buffer and de-ionized (DI) water.

17. The release coating composition for tape of claim 16, wherein when the initiator ranges from 0.1 to 2.0 phr and the buffer ranges from 0.1 to 0.5 phr.

18. The release coating composition for tape of claim 16, wherein the initiator comprisessodium persulfate, ammonium persulphate or potassium persulfate, and the buffer comprises sodium bicarbonate or sodium acetate.

19. The release coating composition for tape of claim 1, wherein the release coating composition is an emulsion in which an average particle size in the emulsion ranges from 0.1 μm to 0.5 μm.

20. The release coating composition for tape of claim 1, wherein a glass-transition temperature (Tg) of the release coating composition ranges between 0° C. and 70° C.

21. The release coating composition for tape of claim 1, wherein a solid content of the release coating composition is from 20% to 60% of a total weight.

22. The release coating composition for tape of claim 1, wherein the release coating composition is adapted for crepe paper tapes, polypropylene tapes, polyester tapes, protective tapes or double-coated tapes.
